(19) United States
(12) Patent Application Publication
(10) Pub. No.: US 2012/0278173 A1
(43) Pub. Date: Nov. 1, 2012

(54) ADVERTISEMENT STORAGE AND RETRIEVAL

(75) Inventors: Shankar Vaidyanathan, Sammamish, WA (US); Balbir Singh, Redmond, WA (US)

(73) Assignee: Microsoft Corporation, Redmond, WA (US)

(21) Appl. No.: 13/097,057

(22) Filed: Apr. 29, 2011

(51) Int. Cl. G06Q 30/00

(52) U.S. Cl. 705/14.58; 705/14.66; 705/14.73

(57) ABSTRACT

Architecture for finding and browsing advertisements presented to a user. In general, the user is able to save advertisements, distribute/share saved advertisements and/or advertisements in the user history, and distribute/share advertisements via existing communication modalities (e.g., email, SMS (short message service), social networks, messaging, etc.). The architecture provides a website the user can access to view the user history of advertisements, coupons, and offers that were presented to the user. Saved advertisements can be made available only for the duration of that particular campaign, beyond which the advertisements can be grayed out and purged with user consent. Additionally, all the advertisements can be published via one or more websites, store advertisements locally on a device, store advertisements in the cloud, and synchronize advertisements across different devices.

### BACKGROUND

Display and search advertisements (ads) can be delivered to users through various properties. Typically, display and content ads are delivered to the user when the user views web properties (e.g., web provider) or when visiting favorite sites (e.g., news, fishing, etc.). Search advertisements appear when the user searches using search engines. The advertisement industry has now evolved such that offers and coupons now appear in mobile and desktop applications and other web properties.

However, the user oftentimes glances at an advertisement or an offer as the user is engrossed in other activities such as researching a task at hand or when reading email or news, for example. When totally engrossed in a focused activity Other than intentional shopping), the user is less likely to pay attention to the advertisement(s) on the page, such as on a side rail or page bottom. It is possible the user viewed a tantalizing advertisement deal on a product (e.g., camera) and/or service the user is researching when the user is working on a related or unrelated task (e.g., composing an email) to a friend. Thereafter, when the user intentionally seeks out this tantalizing advertisement for more information on the deal the advertisement cannot be found.

Display advertisements are not guaranteed to appear again. This happens similarly with search advertisements. The appearance of search advertisements is based on auction, and thus depends on the bidding price, inventory, and the ongoing campaigns at any point of time. In other words, the set of advertisements the user is presented with while searching for a keyword is not likely to be repeated a few hours later even if the user searches using the same keyword.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides the capability to browse for advertisements presented to a user. If the user selected and an advertisement, the architecture also provides the capability to save the advertisement, and to then access past saved advertisements. Additionally, advertisements can be viewed in different ways (e.g., category, format, time, etc.). Moreover, the architecture integrates social networking aspects with the advertisements.

Advertisements, coupons, and offers are typically presented and then are removed or replayed at later times. To address this technique of providing fleeting advertisement content, the architecture provides a website the user can access to view the user history of advertisements, coupons, and offers that were presented to the user. Saved advertisements can be made available only for the duration of that particular campaign, beyond which the advertisements can be grayed out and purged with user consent.

Users can save advertisements by using a selection technique. Additionally, if the user chooses to synchronize advertisements across different devices, the user simply logs into the architecture. If user chooses not to login or has not previously performed a login, the architecture can create cookies (e.g., HTTP—hypertext transfer protocol). When perusing through a list of advertisements previously presented (a history) to the user, the user can choose to save specific advertisements.

In general, the user is able to save advertisements, distribute saved advertisements and/or advertisements in the user history, distribute advertisements via existing communication modalities (e.g., email, SMS (short message service), social networks, messaging, etc.). Additionally, all the advertisements can be published via one or more websites, store advertisements locally on a device, store advertisements in the cloud, and synchronize advertisements across different devices.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an advertisement system in accordance with the disclosed architecture.

FIG. 2 illustrates an alternative system that further employs synchronization and subscription.

FIG. 3 illustrates a system that further employs a security component for authorized and secure handling of user information.

FIG. 4 illustrates a more detailed embodiment of an advertisement system in accordance with the disclosed architecture.

FIG. 5 illustrates an exemplary main advertisement webpage.

FIG. 6 illustrates an exemplary local advertisement webpage.

FIG. 7 illustrates an exemplary user-specific advertisement webpage.

FIG. 8 illustrates a computer-implemented advertisement method in accordance with the disclosed architecture.

FIG. 9 illustrates further aspects of the method of FIG. 8.

FIG. 10 illustrates an alternative advertisement method in accordance with the disclosed architecture.

FIG. 11 illustrates further aspects of the method of FIG. 10.

FIG. 12 illustrates a block diagram of a computing system that executes advertisement selection and storage management in accordance with the disclosed architecture.

### DETAILED DESCRIPTION

The disclosed architecture facilitates the searching and browsing advertisements, and those advertisements presented to a user. In general, the user is able to save advertisements, distribute/share saved advertisements and/or advertisements in the user history, and distribute/share advertisements via existing communication modalities (e.g., email, SMS (short message service), social networks, messaging, etc.). The architecture provides a website the user can access to view the user history of advertisements, coupons, and offers that were presented to the user. Saved advertisements can be made available only for the duration of that particular campaign, beyond which the advertisements can be grayed out and purged with user consent. Additionally, all the advertisements can be published via one or more websites, store advertisements locally on a device, store advertisements in the cloud, and synchronize advertisements across different devices.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

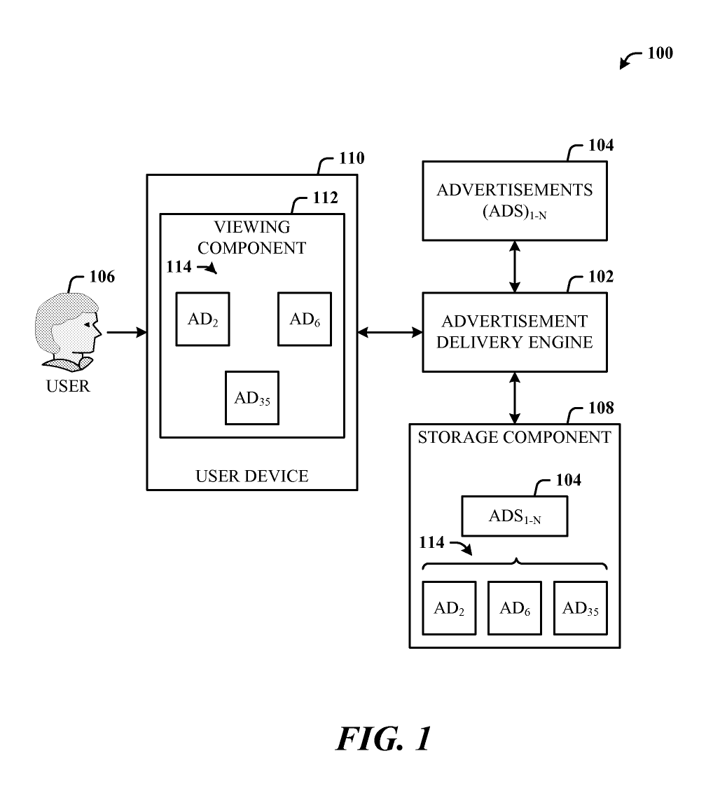

FIG. 1 illustrates an advertisement system 100 in accordance with the disclosed architecture. The system 100 includes an advertisement delivery engine 102 that delivers advertisements 104 for presentation to a user 106, and a storage component 108 that stores the advertisements 104 presented to the user 106 for access and review (e.g., by the user 106).

The user 106 is associated with a user device 110 that includes a viewing component 112 (e.g., a browser) via which the user 106 can view and interact (e.g., navigate) with the advertisements 104 stored in the storage component 108. For example, the user 106 can access and view the advertisements 104 and/or advertisements-of-interest 114 via the viewing component 112. The advertisements-of-interest 114 can be selected from the advertisements 104 and saved in association with a user identifier (user information) of the user 106.

The viewing component 112 enables searching and viewing the advertisements 104 and/or advertisements-of-interest 114 in different ways (e.g., category, content type, format, media type, time stamp, date stamp, etc.). The viewing component 112 can include a browser program that facilitates access to the advertisements 104 and, enables searching and viewing the advertisements in different ways, which ways include at least one of by format, by time, or by category. Additionally, the viewing component 112 enables distribution of an advertisement (e.g., advertisements-of-interest 114, advertisements 104, etc.) to nodes (users, or user devices) of social networks. The storage component 108 can be located locally on the user device 110, in a cloud infrastructure (not shown) or in parts, both locally and in the cloud.

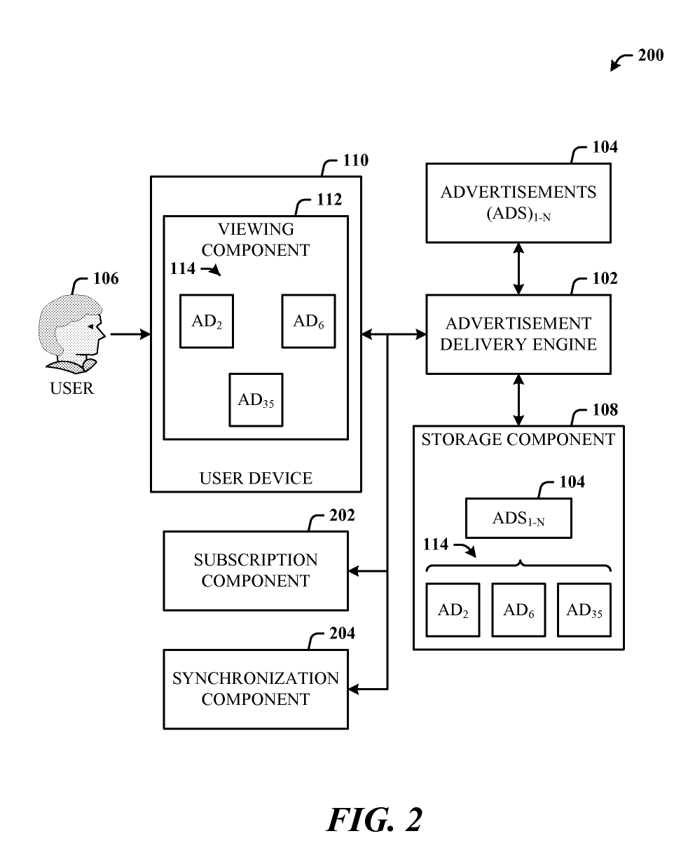

FIG. 2 illustrates an alternative system 200 that further employs synchronization and subscription. The system 200 includes the entities and components of the system 100 of FIG. 1, and further comprises a subscription component 202 that enables subscription only to the advertisements-of-interest 114. The advertisements-of-interest 114 can be pushed to the user 106 based on a subscription or terms of the subscription. The subscription can define the rules, policies, filters, etc., on which the advertisements-of-interest 114 are pushed to the user 106. The subscription can also be utilized to define which advertisements other than the advertisements-of-interest 114 which are pushed to the user 106. In other words, the user 106 can choose to select all advertisements presented in a certain geographic area on a certain day, or during a range of time (e.g., six hours), these advertisements not originally presented to the user 106.

The system 200 can further comprise a synchronization component 204 that synchronizes the advertisement (e.g., advertisements-of-interest 114) across disparate computing devices (e.g., of the user).

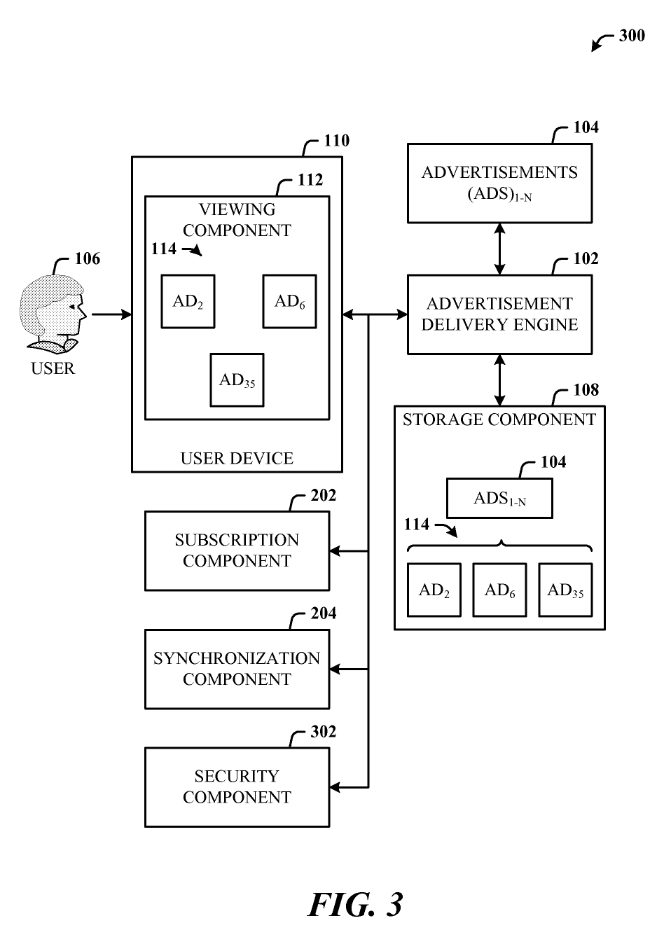

FIG. 3 illustrates a system 300 that further employs a security component 302 for authorized and secure handling of user information. The security component 302 allows the subscriber to opt-in and opt-out of tracking information such as the advertisements-of-interest 114 as well as personal information that may have been obtained at subscription, and then utilized thereafter. The subscriber can be provided with notice of the collection of personal information or advertisements, for example, and the opportunity to provide or deny consent to do so. Consent can take several forms. Opt-in consent imposes on the subscriber to take an affirmative action before the data is collected. Alternatively, opt-out consent imposes on the subscriber an affirmative action to prevent the collection of data before that data is collected. This is similar to implied consent in that by doing nothing, the subscriber allows the data collection after having been adequately informed.

The security component 302 also allows the subscriber to access and update profile information. For example, the subscriber can view the personal and/or tracking data that has been collected, and provide corrections. Where sensitive personal information such as health and financial information can be tracked and obtained during subscription or thereafter, the security component 302 ensures that the data is protected using security measures appropriate for the sensitivity of the data. Moreover, vendor access to such information can be restricted using the security component 302 for access only to authorized viewers.

The security component 302 ensures the proper collection, storage, and access to the subscriber information while allowing for the dynamic selection and presentation of the content, features, and/or services that assist the inactive subscriber to obtain the benefits of a richer user experience and to access to more relevant information.

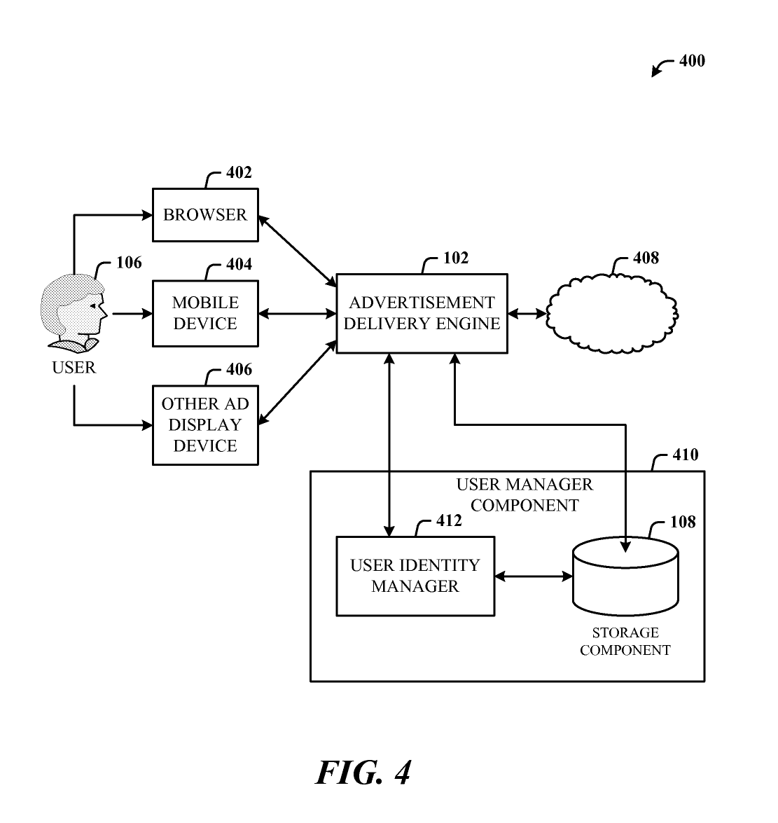

FIG. 4 illustrates a more detailed embodiment of an advertisement system 400 in accordance with the disclosed architecture. As shown, the user 106 can interface to the advertisement delivery engine 102 via means that include a browser 402, a mobile device 404, and other display device 406 (e.g., desktop computer, laptop computer, PDA, etc.). The engine 102 can be configured to store the last N advertisements (e.g., as shown to a given user). Thus, advertisements can be delivered to the user 106 by one or more techniques and one or more devices. The user can explicitly save an advertisement by calling a save API (application programming interface).

The advertisement delivery engine 102 can be a node on a network 408 such as a global communications network (e.g., the Internet) and/or an enterprise network, for example.

A user manager component 410 can be provided to facilitate the assignment of advertisements to the user 106, based on a user identity, as provided by a user identity manager 412. For each request, a user cookie can be utilized to provide the user information (user identifier) to identify the user. The user can retrieve the saved advertisements. Additionally, the user can delete advertisements no longer of interest.

As shown, the user manager component 410 can comprise the storage component 108 that stores user data and advertisement data (e.g., advertisements-of-interest). Note that alternatively, the storage component 108 (e.g., relational database or other database storage technology) can be external to the user management component 410.

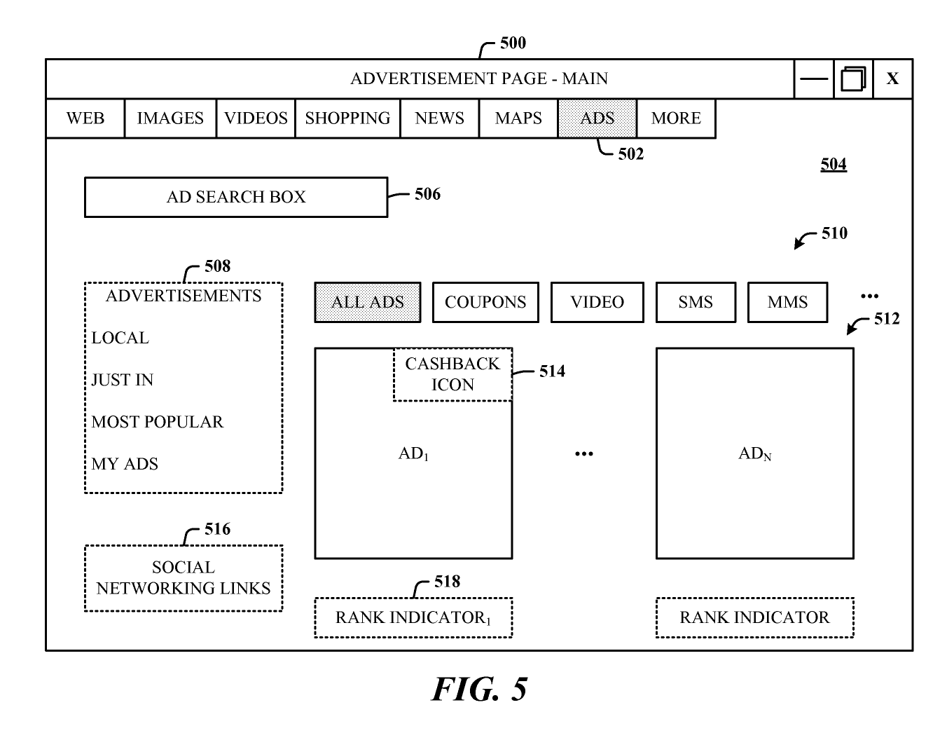

FIG. 5 illustrates an exemplary main advertisement webpage 500. The advertisement website is not limited to searching. The website is also an interesting place to browse advertisements. Thus, advertisements can be presented in interesting ways (e.g., categorized according to the user desires).

The disclosed architecture enables the user to view advertisements for a particular market, a particular business, particular product, and based on categories (e.g., coupons/offers, video advertisements, SMS advertisements, MMS advertisements, audio advertisements, etc. Additionally, advertisements can be viewed based on the largest discount, for a particular location, and advertisements that are most popular.

When selecting an ADS tab 502, the user is presented with an advertisement view 504. The view 504 includes an advertisement search box 506 for searching not only user-selected and saved advertisements (advertisements-of-interest), but also a much larger repository of advertisements not associated with the user, as allowed. The view 504 can also include a specific advertiser area 508 where the user is allowed to select advertisements that are designated local (LOCAL), most recently received (JUST IN), the most popular advertisements (MOST POPULAR) and advertisements associated with the user (MY ADS).

The view 504 can also include advertisement categories 510 such as coupon advertisements, video advertisements, SMS advertisements, MMS advertisements, and so on, as well as all advertisements (ALL ADS).

When the user selects ALL ADS, for example, the view 504 then shows all advertisements 512 (denoted AD₁ . . . AD_{N}). Each advertisement can be presented with an associated cashback icon 514, which when selected enables cash rewards to the user for pursuing the advertisement further (e.g., by clicking-through and navigating to the associated vendor site).

The view 504 can also include a social networking area 516 that provides links to social networking communications technologies (e.g., email, text messaging, voice over IP, etc.). The view 504 can also present a rank indicator 518 for each advertisement (e.g., AD₁). The social networking links 516 can be presented along with a rank indicator (e.g. rank indicator 518) for each advertisement, such that once selected, the associated advertisement is automatically included in the selected communications technology (e.g., email).

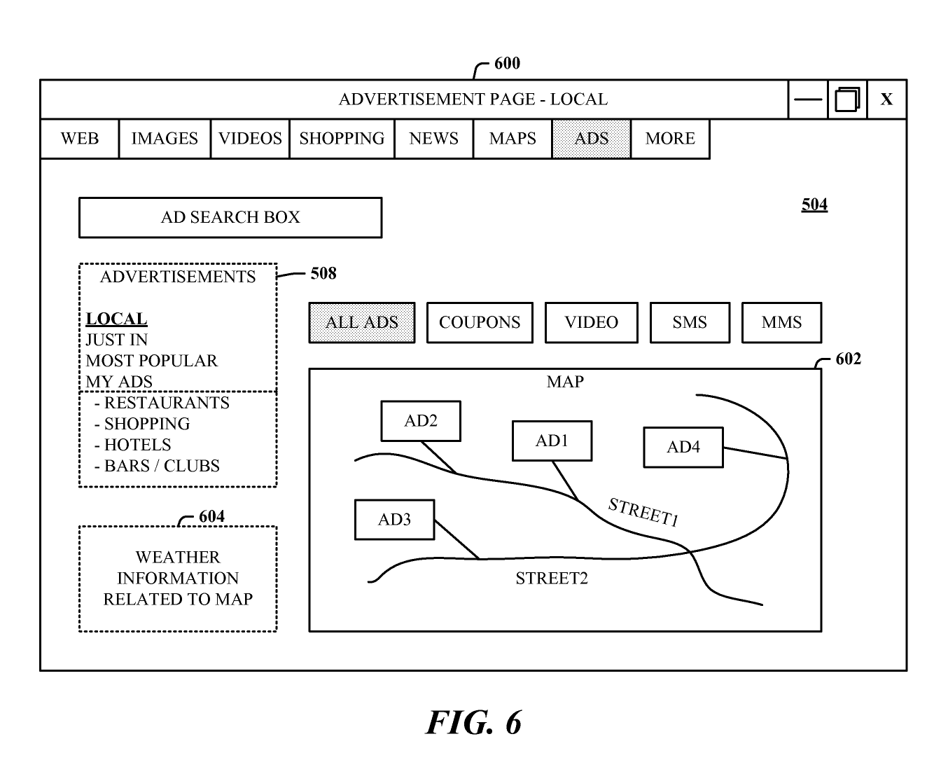

FIG. 6 illustrates an exemplary local advertisement webpage 600. The user can view advertisements for a particular location (e.g., defined in terms of zip codes, DMAs (designated market areas), within a radius of a latitude-longitude, etc.). As the architecture overlay advertisements against a local map with offers/coupons from the restaurants, entertainment, movie theaters, shopping, this becomes a useful tool. When adding the weather and traffic information, buddies nearby that location, etc., the tool can be indispensable not just for teenagers but for users from all walks of life. Moreover, enabling the specification of a new location that can replace the user's current default location makes it easy to plan on trips or organize meetings in other locations and cities.

When selecting the Local setting in the specific advertiser area 508, the view 504 can show advertisements associated restaurants, shopping, hotels, and bars/clubs. Additionally, the view 504 can include a geographical map 602 that shows streets, for example, and the location of the vendor associated with the advertisements. For example, advertisements AD1 and AD2 are show in the map 602 as located on a street Street1 and, advertisements AD3 and AD4 are associated with vendors located on a street Street2. The view 504 can also include weather and traffic information 604 related to the geographic area of the map 602.

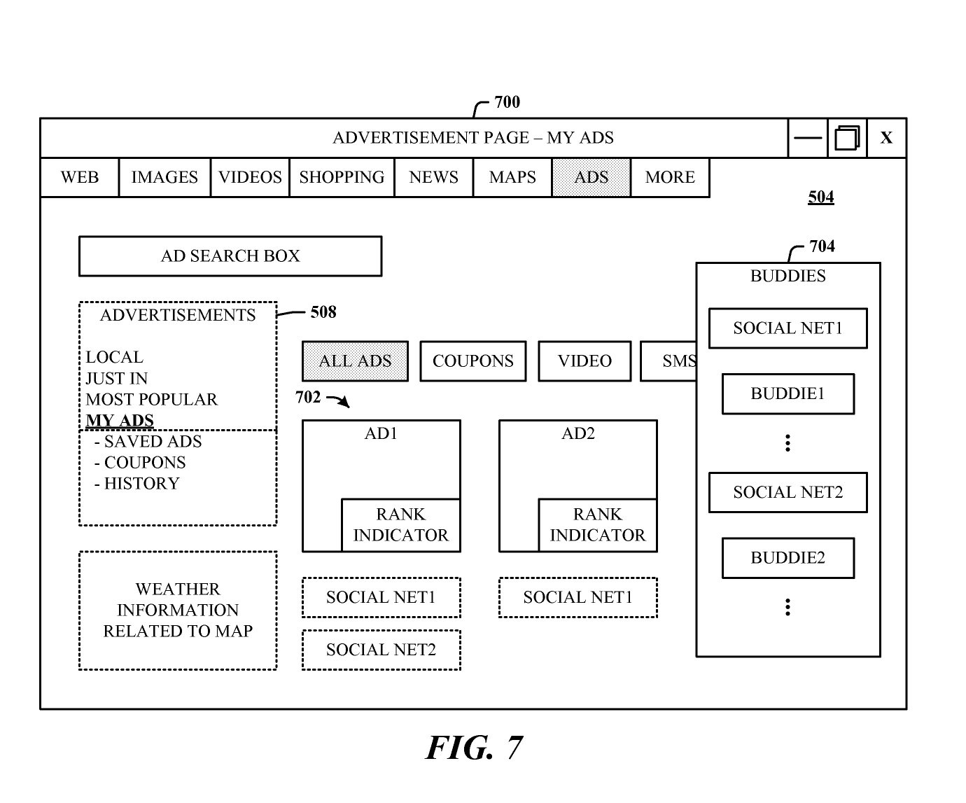

FIG. 7 illustrates an exemplary user-specific advertisement webpage 700. Also referred to as a My Ads page 700, the user can browse through all the advertisements that were displayed to the user across various applications and web browsing on the device, and across multiple devices. Once again, the user can view the advertisements based on the application via which a specific advertisement was displayed or experienced (e.g., video, audio, etc.), the time period over which the user is interested, the advertiser/advertisements in which the user is most interested, etc.

Here, the user has selected the MY ADS selection in the specific advertiser area 508. The view 504 then shows two advertisements 702, associated rank indicators, and associated social networks. Additionally, a buddies panel 704 is shown that indicates the buddies (friends) of the user and the social network via which the buddy can be reached (communicated with).

In an alternative embodiment, the view 504 can include scroll controls (not shown) that enable the user to view (navigate left or right) among all the advertisements designated as specific to the user.

More generally, the disclosed architecture provides a mechanism by which users can search for advertisements. For example, if the user is looking for deals on a model of camera, the user go to the advertisements website to search and access all advertisements from different dealers. Moreover, the search functionality can be employed as a platform to allow different advertisement providers to participate and showcase wares. Thus, the architecture can provide a website that is a publisher for third-party advertisements. The search functionality can facilitate searching on advertisement metadata for example.

The disclosed architecture also preserves the functionality of the advertisements. Although advertisements (as referred to herein also include coupons, offers, etc.) are not persisted for a long time, the user can access the advertisements website to browse through a user your history of advertisements (which also include and coupons, offers, etc.) and explicitly save the advertisements for later use. Saved advertisements may only be available for the duration of that particular campaign, beyond which the advertisements will be presented with visual emphasis (e.g., grayed out) and purged, based on user consent.

The identification of specific advertisements with users provides rich source of users to direct targeted advertising. The increased understanding about the consumer, the products of interest to the consumer, and type of behavior all provide a basis for establishing and obtaining advertising revenue from vendors.

The architecture also provides the capability to layer different filters on the resultant data. For example, by applying stacking different filters, it is possible to see advertisers/advertisements of a particular category only from local merchants. Moreover, the results can also be sorted by available fields including price, availability, rank, distance, etc. The cashback logo (cashback icon 514) is an additional lure for consumers and customers to seamlessly participate in a cashback program.

The architecture provides access to social networking such that every advertisement can readily be communicated (e.g., SMS, emailed, etc.). Additionally, each advertisement can be ranked and rated. The user's contacts and other social networks are seamlessly integrated into the user experience once the user navigates to the user-specific page (e.g., MY ADS). Thus, the user can share, comment, and rate the advertisements (e.g., coupons, offers, etc.).

Accordingly, when the user logs in to the advertisement website, the user is able to send an advertisement to a buddy or family member using a drag-and-drop operation, for example. The user can share a coupon by email, instant messaging, SMS, MMS, voice, audio, etc. It is also within contemplation of the disclosed architecture that advertisers can mark the advertisements appropriately to prevent certain advertisements from being shared or saved. Additionally, all the advertisements the user has forwarded to other users and that other users have forwarded to the user are tracked and, can be made accessible and retrievable.

Advertisements can be found in the user history that were either displayed to a buddy circle or redeemed by a buddy.

The architecture also enumerates the category or the type of advertisements that the user prefers. In other words, the user profile can be updated by inference according to user saved advertisements. For example, consider that the user is looking for a vehicle, which is mentioned in the user profile. Thus, related advertisements can then be pushed to the user in the user-specific are (e.g., MY ADS tab) as the user browses the advertisements website.

In another example of the usefulness of the user profile is if user is planning an upcoming vacation plan to a country, it would be desirable to access a single webpage that provides a large amount of advertisements related to the best deals for air travel, hotels, interesting places to visit, and items to shop before and during the trip to the country. The disclosed architecture provides this capability and an effective source where the right advertisers are matched with the right consumers.

Additionally, feedback can be provided to the advertiser. The user can provide feedback to the advertisers so that the advertisers can fine tune their presence and appearance to a given user, for example. In other words, the user can describe (e.g., anonymously) the desired store front experience to the advertiser to help the advertiser provide a more desirable experience.

As part of the social networking experience, the user can also be interested in the community aspects of advertising and not just amongst personal contacts. Thus, by selecting a “Most Popular” tab results in receiving community reviews for advertisements. Additionally, community aspects advertising can be surfaced. This includes, but not limited to, actions such as rate and review advertisements, access and view the most popular advertisements (e.g., based on the votes received), access and review the most viewed advertisements, access and review the most shared advertisements (e.g., coupons), access and review coupons that offer the greatest discount and, access and review the most hated advertisements or the duds, etc.

There also can be a mechanism whereby public feedback from others can be viewed for any particular advertiser or advertisement, and also provide comments on the feedback of other users.

For example, the user can apply the a buddy (My Buddy) filter to a set of information to find the most rated/ranked advertisements among buddies, the most popular advertisements among buddies, etc. Another filter is a My Community filter whereby the user can see the most popular, the most viewed, etc., among the community in which the user abides (where community can be defined as people living in the same zip Code/DMA).

The architecture can also utilize RSS (really simple syndication) feeds for advertisements. An RSS feed can be used to receive only those advertisements related to a specific product or service. RSS for advertisements can be the way consumers and advertisers communicate during the evaluation phase, and RSS channels can help consumers work with multiple advertisers to make the right choice/purchase. Moreover, RSS for advertisements improves the targeting ability of advertisers to users, since the user's intent is now very well understood and the right consumers can be connected with the right set of advertisers.

The RSS feeds can be modulated for the consumers/publisher needs. It becomes possible to subscribe to specific categories of advertisements, advertisements from specific advertisers, advertisements for specific products, advertisements from the Local tab, advertisements from the MY ADS tab, etc.

Additionally, publishers of other sites can obtain advertising content from the advertisements website via portals with RSS feeds of the appropriate advertisements. This functionality could be considered as a more sophisticated version of content advertisements for the publishers.

The disclosed architecture also supports the implementation mobile enabled websites for rich mobile browsers (e.g., via a smart mobile ad client (SMACk)). The client runtime can provide a useful, engaging, and entertaining experience to the user by further exploiting the capabilities of the mobile device (e.g., compass, geolocation systems such as GPS (global positioning system), accelerometer, camera, etc.), location, context, and demographics of the consumer. In addition, the architecture can support scenarios where advertisements interact with the host mobile device to add a number to the contacts list, bring up maps for location, and/or to forward the address to the navigation device.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

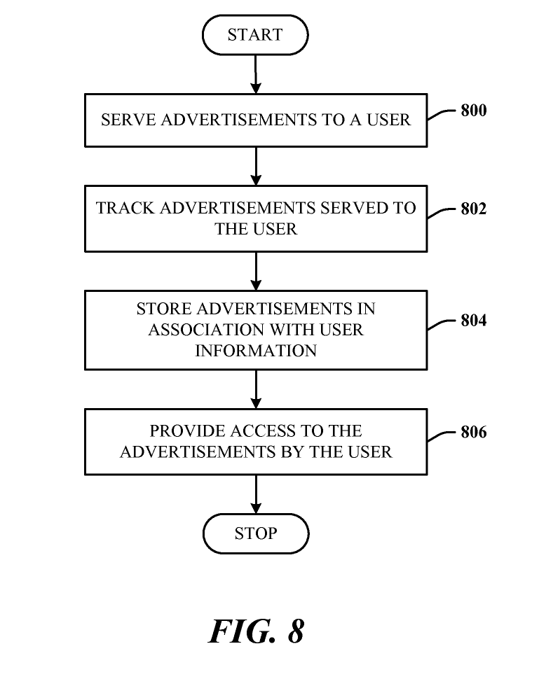

FIG. 8 illustrates a computer-implemented advertisement method in accordance with the disclosed architecture. At 800, advertisements are served to a user. The advertisements are served when a user accesses a webpage that includes advertising content. The advertisements include any type of advertisement and of any media type (e.g., text, image, video, etc.). At 802, the advertisements served to the user are tracked. User information, such as a user identifier, is employed to tag or store the advertisements presented to the user. At 804, the advertisements are stored in association with user information. As previously indicated, the storage can be local storage devices such as hard drives, flash drives, network-based storage such as cloud storage facilitates, distributed storage systems, and so on. At 806, access to the advertisements is provided to the user. Access can be provided via the advertisement website and associated storage systems.

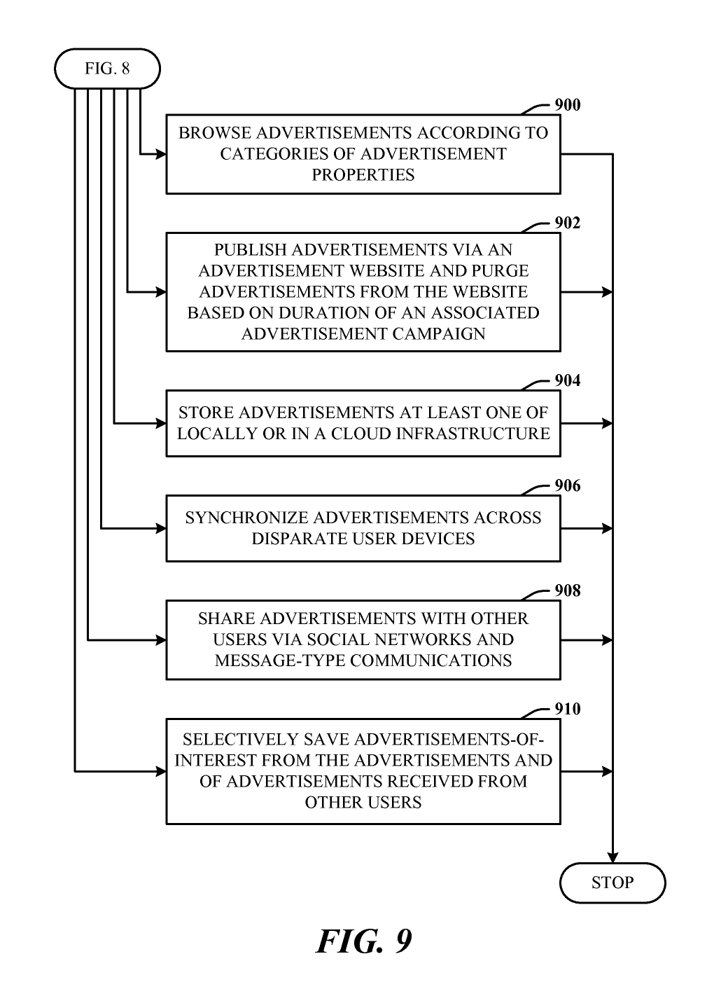

FIG. 9 illustrates further aspects of the method of FIG. 8. Note that the flow indicates that each block can represent a step that can be included, separately or in combination with other blocks, as additional aspects of the method represented by the flow chart of FIG. 8. At 900, the advertisements are browsed (e.g., using a browser program) according to categories of advertisement properties. For example, the categories can include search advertisement (presented when performing a search operation), display advertisements, content advertisements, etc., and any other advertisement types that include coupons, offers, etc. At 902, the advertisements are published via an advertisement website and one or more advertisements are purged from the website based on duration of an associated advertisement campaign. At 904, the advertisements are stored at least one of locally or in a cloud infrastructure. At 906, the advertisements can be synchronized across disparate user devices. At 908, the advertisements can be shared with other users via social networks and message-type communications (e.g., email, RSS, SMS (short message service), MMS (multimedia messaging system), voice, etc. At 910, advertisements-of-interest are selectively saved from the advertisements and of advertisements received from other users.

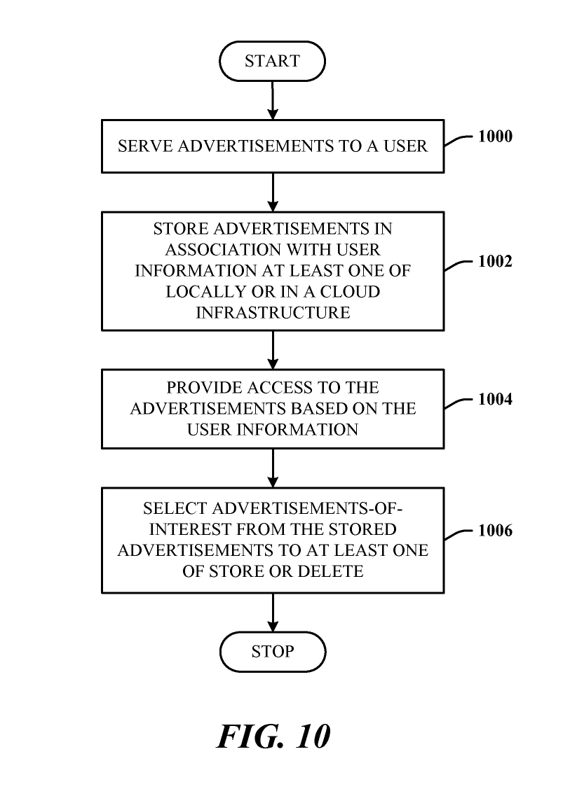

FIG. 10 illustrates an alternative advertisement method in accordance with the disclosed architecture. At 1000, advertisements are served to a user. At 1002, the advertisements are stored in association with user information at least one of locally or in a cloud infrastructure. At 1004, access to the advertisements is provided (e.g., to the user) based on the user information. At 1006, advertisements-of-interest are selected from the stored advertisements to at least one of store or delete. In other words, the user can peruse advertisements stored centrally, and select advertisements to be associated with the user information.

Alternatively, or in combination therewith, the user can access the storage system (local, distributed, cloud) and be directed to a user account of the user that only stores the advertisements that were presented to the user when the user accessed a webpage or other type of presentation system that presents advertisements.

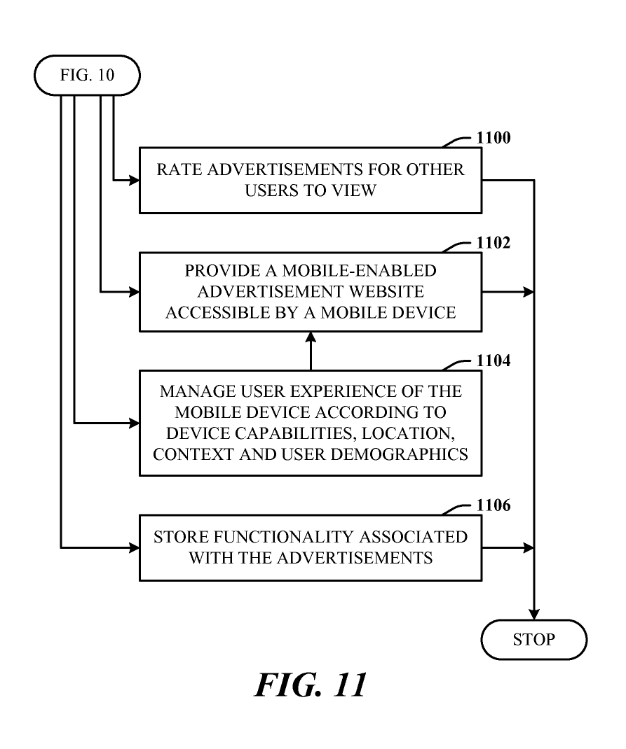

FIG. 11 illustrates further aspects of the method of FIG. 10. Note that the flow indicates that each block can represent a step that can be included, separately or in combination with other blocks, as additional aspects of the method represented by the flow chart of FIG. 10. At 1100, the advertisements are rated by a user for other users to view. At 1102, a mobile-enabled advertisement website is presented for access by a mobile device. At 1104, a user experience of the mobile device is managed according to device capabilities, location, context, and/or user demographics. At 1106, functionality associated with the advertisements is also stored. In other words, if the advertisements, as normally presented to any user, expands and then contracts in size, this same functionality is preserved as part of storing the advertisement in association with the user.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

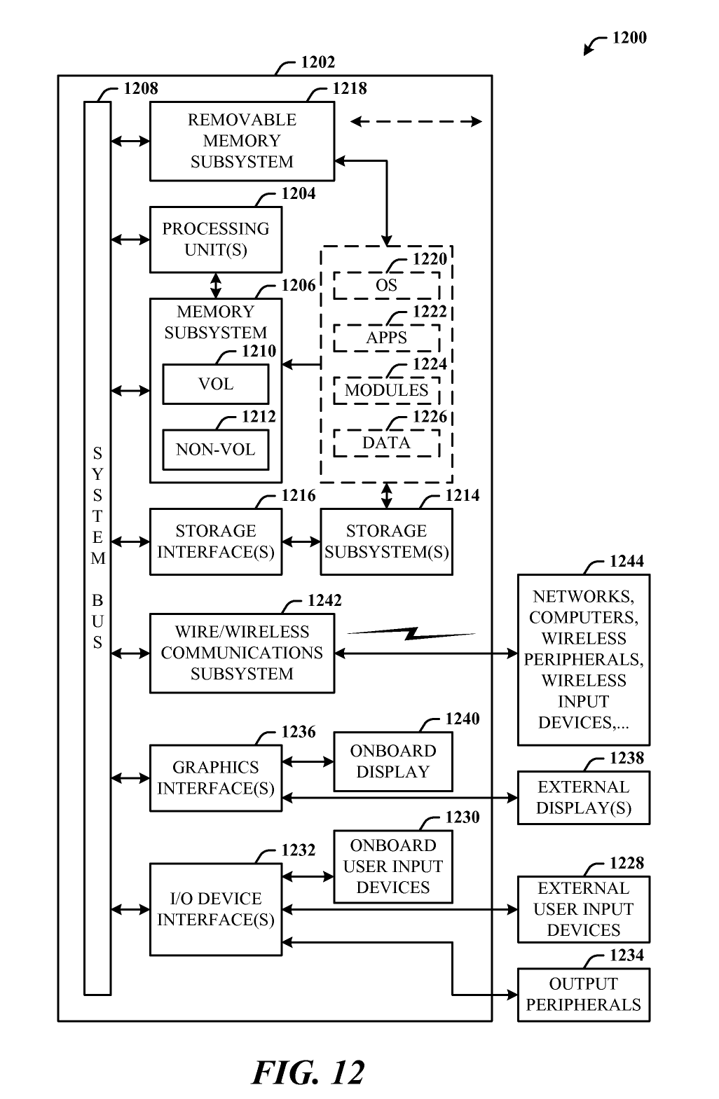

Referring now to FIG. 12, there is illustrated a block diagram of a computing system 1200 that executes advertisement selection and storage management in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 12 and the following description are intended to provide a brief, general description of the suitable computing system 1200 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1200 for implementing various aspects includes the computer 1202 having processing unit(s) 1204, a computer-readable storage such as a system memory 1206, and a system bus 1208. The processing unit(s) 1204 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1206 can include computer-readable storage (physical storage media) such as a volatile (VOL) memory 1210 (e.g., random access memory (RAM)) and non-volatile memory (NON-VOL) 1212 (e.g., ROM, EPROM, EEPROM, etc.). A basic input/output system (BIOS) can be stored in the non-volatile memory 1212, and includes the basic routines that facilitate the communication of data and signals between components within the computer 1202, such as during startup. The volatile memory 1210 can also include a high-speed RAM such as static RAM for caching data.

The system bus 1208 provides an interface for system components including, but not limited to, the system memory 1206 to the processing unit(s) 1204. The system bus 1208 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1202 further includes machine readable storage subsystem(s) 1214 and storage interface(s) 1216 for interfacing the storage subsystem(s) 1214 to the system bus 1208 and other desired computer components. The storage subsystem(s) 1214 (physical storage media) can include one or more of a hard disk drive (HDD), a magnetic floppy disk drive (FDD), and/or optical disk storage drive (e.g., a CD-ROM drive DVD drive), for example. The storage interface(s) 1216 can include interface technologies such as EIDE, ATA, SATA, and IEEE 1394, for example.

One or more programs and data can be stored in the memory subsystem 1206, a machine readable and removable memory subsystem 1218 (e.g., flash drive form factor technology), and/or the storage subsystem(s) 1214 (e.g., optical, magnetic, solid state), including an operating system 1220, one or more application programs 1222, other program modules 1224, and program data 1226.

The operating system 1220, one or more application programs 1222, other program modules 1224, and/or program data 1226 can include the entities and components of the system 100 of FIG. 1, the entities and components of the system 200 of FIG. 2, the entities and components of the system 300 of FIG. 3, the entities and components of the system 400 of FIG. 4, the webpages (500, 600, and 700) of FIGS. 5-7, and the methods represented by the flowcharts of FIGS. 8-11, for example.

Generally, programs include routines, methods, data structures, other software components, etc., that perform particular tasks or implement particular abstract data types. All or portions of the operating system 1220, applications 1222, modules 1224, and/or data 1226 can also be cached in memory such as the volatile memory 1210, for example. It is to be appreciated that the disclosed architecture can be implemented with various commercially available operating systems or combinations of operating systems (e.g., as virtual machines).

The storage subsystem(s) 1214 and memory subsystems (1206 and 1218) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1202 and includes volatile and non-volatile internal and/or external media that is removable or non-removable. For the computer 1202, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1202, programs, and data using external user input devices 1228 such as a keyboard and a mouse. Other external user input devices 1228 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1202, programs, and data using onboard user input devices 1230 such a touchpad, microphone, keyboard, etc., where the computer 1202 is a portable computer, for example. These and other input devices are connected to the processing unit(s) 1204 through input/output (I/O) device interface(s) 1232 via the system bus 1208, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1232 also facilitate the use of output peripherals 1234 such as printers, audio devices, camera devices, and so on, such as a sound card and/or onboard audio processing capability.

One or more graphics interface(s) 1236 (also commonly referred to as a graphics processing unit (GPU)) provide graphics and video signals between the computer 1202 and external display(s) 1238 (e.g., LCD, plasma) and/or onboard displays 1240 (e.g., for portable computer). The graphics interface(s) 1236 can also be manufactured as part of the computer system board.

The computer 1202 can operate in a networked environment (e.g., IP-based) using logical connections via a wired/wireless communications subsystem 1242 to one or more networks and/or other computers. The other computers can include workstations, servers, routers, personal computers, microprocessor-based entertainment appliances, peer devices or other common network nodes, and typically include many or all of the elements described relative to the computer 1202. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1202 connects to the network via a wired/wireless communication subsystem 1242 (e.g., a network interface adapter, onboard transceiver subsystem, etc.) to communicate with wired/wireless networks, wired/wireless printers, wired/wireless input devices 1244, and so on. The computer 1202 can include a modem or other means for establishing communications over the network. In a networked environment, programs and data relative to the computer 1202 can be stored in the remote memory/storage device, as is associated with a distributed system. It will be appreciated that the network connections shown are exemplary and other means of establishing a communications link between the computers can be used.

The computer 1202 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented advertisement system, comprising:
an advertisement delivery engine that delivers advertisements for presentation to a user;
a storage component that stores the advertisements presented to the user for access and review; and
a processor that executes computer-executable instructions associated with at least one of the delivery engine or the storage component.

2. The system of claim 1, wherein the storage component is located at least one of local on a user device or in a cloud infrastructure.

3. The system of claim 1, wherein the advertisements include advertisements-of-interest to the user, the advertisements-of-interest are selected from the advertisements and saved in association with the user according to a user identifier.

4. The system of claim 1, further comprising a viewing component via which the advertisements are accessed and viewed.

5. The system of claim 4, wherein the viewing component enables searching and viewing the advertisements in different ways.

6. The system of claim 4, wherein the viewing component includes a browser program that facilitates access to the advertisements and, enables searching and viewing the advertisements in different ways, which ways include at least one of by format, by time, or by category.

7. The system of claim 4, wherein the viewing component enables distribution of an advertisement to nodes of social networks.

8. The system of claim 1, further comprising a subscription component that enables subscription only to advertisements-of-interest, the advertisements-of-interest are pushed to the user.

9. The system of claim 1, further comprising a synchronization component that synchronizes the advertisements across disparate computing devices.

10. A computer-implemented advertisement method, comprising acts of:
serving advertisements to a user;
tracking the advertisements served to the user;
storing the advertisements in association with user information;
providing access to the advertisements to the user; and
utilizing a processor that executes instructions stored in memory to perform at least one of the acts of serving, tracking, storing, or providing.

11. The method of claim 10, further comprising browsing the advertisements according to categories of advertisement properties.

12. The method of claim 10, further comprising publishing the advertisements via an advertisement website and purging advertisements from the website based on duration of an associated advertisement campaign.

13. The method of claim 10, further comprising storing the advertisements at least one of locally or in a cloud infrastructure.

14. The method of claim 10, further comprising synchronizing the advertisements across disparate user devices.

15. The method of claim 10, further comprising sharing the advertisements with other users via social networks and message-type communications.

16. The method of claim 10, further comprising selectively saving advertisements-of-interest from the advertisements and of advertisements received from other users.

17. A computer-implemented advertisement method, comprising acts of:
serving advertisements to a user;
storing the advertisements in association with user information at least one of locally or in a cloud infrastructure;
providing access to the advertisements based on the user information;
selecting advertisements-of-interest from the stored advertisements to at least one of store or delete; and
utilizing a processor that executes instructions stored in memory to perform at least one of the acts of serving, storing, selecting, or providing.

18. The method of claim 17, further comprising rating the advertisements for other users to view.

19. The method of claim 17, further comprising;
providing a mobile-enabled advertisement website accessible by a mobile device; and
managing a user experience of the mobile device according to device capabilities, location, context, and user demographics.

20. The method of claim 17, further comprising storing functionality associated with the advertisements.
